(19) United States
(12) Patent Application Publication
(10) Pub. No.: US 2025/0104928 A1
(43) Pub. Date: Mar. 27, 2025

(54) ELECTROLYTIC CAPACITOR AND METHOD OF MANUFACTURING SAME

(71) Applicant: Panasonic Intellectual Property Management Co., Ltd., Osaka (JP)

(72) Inventors: RYO KOSAKA, Osaka (JP); NAOKI UMAHASHI, Osaka (JP); TAKAHIRO YOSHII, Osaka (JP); DAISUKE KUBO, Osaka (JP)

(21) Appl. No.: 18/822,362

(22) Filed: Sep. 2, 2024

(30) Foreign Application Priority Data
Sep. 26, 2023 (JP) 2023-163633

(51) Int. Cl. H01G 9/028; H01G 9/00; H01G 9/048; H01G 9/15

(52) U.S. Cl. CPC H01G 9/028; H01G 9/0032; H01G 9/0036; H01G 9/048; H01G 9/15

(57) ABSTRACT

An electrolytic capacitor includes at least one capacitor element including: an anode body including a porous part in a surface layer; a dielectric layer covering at least a part of a surface of the anode body; and a solid electrolyte layer covering at least a part of the dielectric layer. The solid electrolyte layer includes, in the anode body, a first portion disposed in a void of the porous part, and a second portion disposed outside a principal surface of the anode body. The second portion includes n or more conductive polymer layers on one principal surface of the anode body. Following relational expressions are satisfied:

$$\begin{matrix}18. μm \leq T t \leq 50. μm \\ 9. μm \leq Tt / n \leq 12.5 μm\end{matrix}$$

where, n is an integer of 2 or more, and Tt is a thickness of the second portion on one principal surface of the anode body having the dielectric layer.

### BACKGROUND

### 1. Technical Field

The present disclosure relates to an electrolytic capacitor and a method of manufacturing an electrolytic capacitor.

### 2. Description of the Related Art

An electrolytic capacitor includes capacitor elements, a case that seals the capacitor elements, and an external electrode electrically connected with the capacitor elements. The capacitor element includes an anode body, a dielectric layer, and a cathode part. The anode body includes an anode lead-out part that includes a first end and a cathode forming part that includes a second end. The dielectric layer is formed at least on a surface of the cathode formation part of the anode body. The cathode part covers at least a portion of the dielectric layer. The cathode part includes a solid electrolyte layer and a cathode lead-out layer. The solid electrolyte layer covers at least a part of the dielectric layer and contains a conductive polymer. The cathode lead-out layer covers at least a part of the solid electrolyte layer. An electrolytic capacitor that includes a solid electrolyte layer containing a conductive polymer is also referred to as a solid electrolytic capacitor.

International Publication WO2014/087617 proposes a method of manufacturing a solid electrolytic capacitor including a capacitor element having a dielectric layer and a solid electrolyte layer, in which formation of the solid electrolyte layer includes a step of sequentially performing: a first step of applying a first conductive polymer solution in which fine particles of a conductive polymer are dispersed and drying the first conductive polymer solution to form a first conductive polymer layer; a second step of applying a coating solution containing at least one selected from aromatic sulfonic acid having a carboxy group and a hydroxy group or two carboxy groups in one molecule or a salt thereof to the first conductive polymer layer and drying the coating solution; and a third step of applying a second conductive polymer solution in which fine particles of a conductive polymer are dispersed and drying the second conductive polymer solution to form a second conductive polymer layer.

International Publication WO2021/132223 proposes an electrolytic capacitor including at least one capacitor element including: a sheet-like anode body having an anode lead-out part including a first end and a cathode formation part including a second end; a dielectric layer formed on a surface of at least the cathode formation part of the anode body; and a cathode part covering at least a part of the dielectric layer, in which the cathode part includes a solid electrolyte layer containing a conductive polymer covering at least a part of the dielectric layer, and in a cross section perpendicular to a direction from the first end toward the second end of the capacitor element at an arbitrary position of a portion of the cathode part on a side of the first end, a ratio T1/T2 of a thickness T1 of the solid electrolyte layer formed at a corner portion of the anode body to a thickness T2 of the solid electrolyte layer formed in a central portion of a principal surface of the anode body is 0.8 or more and 1.7 or less.

### SUMMARY

One aspect of the present disclosure relates to an electrolytic capacitor including at least one capacitor element including: an anode body including a porous part in a surface layer; a dielectric layer covering at least a part of a surface of the anode body; and a solid electrolyte layer covering at least a part of the dielectric layer. The anode body includes a first end and a second end opposite to the first end. The solid electrolyte layer is disposed in a portion including the second end of the anode body having the dielectric layer, and includes a first portion disposed in a void of the porous part and a second portion disposed outside a principal surface of the anode body having the dielectric layer. The second portion includes n or more conductive polymer layers on the principal surface of the anode body having the dielectric layer, and following relational expressions are satisfied.

$$\begin{matrix}18. μm \leq T t \leq 50. μm \\ 9. μm \leq Tt / n \leq 12.5 μm\end{matrix}$$

where, n is an integer of 2 or more, and Tt is a thickness of the second portion on one principal surface of the anode body having the dielectric layer at the second end.

Another aspect of the present disclosure relates to a method of manufacturing an electrolytic capacitor. The manufacturing method includes: a first step of preparing an anode body including a porous part in a surface layer and including a first end and a second end opposite to the first end; a second step of forming a dielectric layer on at least a part of a surface of the anode body; and a third step of forming a solid electrolyte layer covering at least a part of the dielectric layer. The solid electrolyte layer is formed in a portion including the second end of the anode body having the dielectric layer, and includes a first portion disposed in a void of the porous part and a second portion disposed outside a principal surface of the anode body having the dielectric layer. The second portion includes n or more conductive polymer layers on the principal surface of the anode body having the dielectric layer. The third step includes: a substep A of treating the portion including the second end of the anode body having the dielectric layer with a first treatment liquid including a first conductive polymer or a precursor of the first conductive polymer; a substep B of treating the portion including the second end of the anode body with a second treatment liquid including at least a cationic agent after the substep A; a substep C of treating the portion including the second end of the anode body with a third treatment liquid including a second conductive polymer and a water-soluble polymer after the substep B; and a substep D of repeating the substep B and the substep C. In the third step, the solid electrolyte layer is formed to satisfy following relational expressions.

$$\begin{matrix}18. μm \leq Tt \leq 45. μm \\ 9. μm \leq Tt / n \leq 12.5 μm\end{matrix}$$

where, n is an integer of 2 or more, and Tt is a thickness of the second portion on the principal surface of the anode body having the dielectric layer at the second end.

The present disclosure provides an electrolytic capacitor capable of securing high withstand voltage characteristics and suppressing a leakage current.

### BRIEF DESCRIPTION OF THE DRAWINGS

FIG. 1 is a schematic cross-sectional view illustrating an electrolytic capacitor according to an exemplary embodiment of the present disclosure.

### DETAILED DESCRIPTIONS OF EMBODIMENTS

Hereinafter, problems of the prior art will be briefly described.

In the electrolytic capacitor of the prior art, it has been insufficient to secure high withstand voltage characteristics and suppress a leakage current.

In the electrolytic capacitor including a solid electrolyte layer, in a case where the solid electrolyte layer has a certain thickness, it is expected that a leakage current can be reduced and high withstand voltage characteristics can be obtained as compared with the case where the thickness is small. However, when the thickness of the solid electrolyte is further increased, although higher withstand voltage characteristics can be obtained, thermal shrinkage of the solid electrolyte occurs in the process of forming the solid electrolyte. Thus, the stress associated with this thermal shrinkage causes defects in a dielectric layer, leading to an increase in leakage current.

The solid electrolyte layer is formed by, for example, applying a treatment liquid containing a conductive polymer to an anode body having the dielectric layer, followed by drying, or applying a treatment liquid containing a precursor (such as a monomer) of a conductive polymer, followed by polymerizing the precursor. When such application and drying (or polymerization) of the treatment liquid are repeated a plurality of times, the conductive polymer is stacked in a plurality of layers, and the thickness of the entire solid electrolyte layer to be formed can be increased. However, interface resistance is generated between adjacent layers of the conductive polymer, so that the conductivity of the solid electrolyte layer decreases. Thus, equivalent series resistance (ESR) in the electrolytic capacitor increases. Furthermore, when the application and drying (or polymerization) of the treatment liquid are repeated a plurality of times, the number of steps increases, which is disadvantageous in terms of cost.

### (Technology 1)

An electrolytic capacitor according to one aspect of the present disclosure includes at least one capacitor element including: an anode body including a porous part in a surface layer; a dielectric layer covering at least a part of a surface of the anode body; and a solid electrolyte layer covering at least a part of the dielectric layer. The anode body includes a first end and a second end opposite to the first end. The solid electrolyte layer is disposed in a portion including the second end of the anode body having the dielectric layer, and includes a first portion disposed in a void of the porous part and a second portion disposed outside a principal surface of the anode body having the dielectric layer. The second portion includes n or more conductive polymer layers on the principal surface of the anode body having the dielectric layer, and following relational expressions are satisfied.

$$\begin{matrix}18. μm \leq T t \leq 50. μm \\ 9. μm \leq Tt / n \leq 12.5 μm\end{matrix}$$

where, n is an integer of 2 or more, and Tt is a thickness of the second portion on one principal surface of the anode body having the dielectric layer at the second end. In the present specification, the conductive polymer layer mainly included in the first portion may be referred to as a first conductive polymer layer, and the conductive polymer layer mainly included in the second portion may be referred to as a second conductive polymer layer.

According to the electrolytic capacitor of the present disclosure, as described above, the thickness Tt of the second portion on the principal surface of the solid electrolyte layer falls within a specific range, the ratio Tt/n falls within a specific range, and n is an integer of 2 or more. As a result, a leakage current can be suppressed, and high withstand voltage characteristics can be obtained. Since the ratio Tt/n is relatively large, the thickness Tt can be relatively large even when the number n of the second conductive polymer layers is relatively small. Therefore, the stress applied to the dielectric layer can be reduced by the thermal shrinkage of the second conductive polymer layer due to the heat treatment (drying or the like) at the time of forming the second portion, and the leakage current can be suppressed. Furthermore, the high withstand voltage characteristics are considered to be due to both the thickness Tt and the ratio Tt/n being relatively large. In addition, the electrolytic capacitor of the present disclosure can ensure low ESR. This is considered to be because the number n of the second conductive polymer layers is relatively small, so that the total value of interface resistances between the second conductive polymer layers in the second portion can be reduced, and high conductivity of the second portion can be secured.

Note that the ratio Tt/n can be roughly considered as an average thickness of one conductive polymer layer in the second portion.

### (Technology 2)

In the above (Technology 1), the integer n may be 4 or less. In this case, since the total value of the interface resistances between the second conductive polymer layers can be further reduced, lower ESR is easily obtained.

### (Technology 3)

In the above (Technology 1) or (Technology 2), a following relational expression is further satisfied, 20.0 μm<Tt. In this case, it is easy to secure higher withstand voltage characteristics. Furthermore, when the thickness Tt is large, a defect is generated in the dielectric layer due to stress associated with thermal shrinkage, and a leakage current tends to be remarkable. However, in the present disclosure, since the thickness Tt/n and the number of the second conductive polymer layers fall within specific ranges, the leakage current can be kept low even when the thickness Tt is as relatively large as 20 μm<Tt≤45.0 μm.

### (Technology 4)

In any one of (Technology 1) to (Technology 3), the second portion may include a water-soluble polymer. A weight-average molecular weight (Mw) of the water-soluble polymer may be 50,000 or more and 800,000 or less. When the second portion includes the water-soluble polymer, a conductive polymer layer having a relatively uniform thickness is easily formed, and higher withstand voltage characteristics can be obtained. In a case where the weight-average molecular weight (Mw) of the water-soluble polymer is in the above range, the thickness Tt and the ratio Tt/n can be easily adjusted to the above ranges even if the number n of layers is relatively small as compared with the case outside the above range. Therefore, higher withstand voltage characteristics can be obtained. Furthermore, it is easy to further reduce the total value of the interface resistances between the adjacent second conductive polymer layers. Since higher conductivity of the entire second portion can be secured, ESR can be further reduced. Since the number n of layers can be made relatively small, it is easy to reduce the stress applied to the dielectric layer by the thermal shrinkage of the second portion, and it is easy to further reduce the leakage current. Furthermore, in a case where a weight-average molecular weight (Mw) of the water-soluble polymer is 50,000 or more and 800,000 or less, it is easy to form the second conductive polymer layer having relatively uniform film quality and thickness.

### (Technology 5)

In the above (Technology 4), a content proportion of the water-soluble polymer in the second portion may be 10 mass % or more and 20 mass % or less. In this case, the effect of the water-soluble polymer is easily obtained. Therefore, higher withstand voltage characteristics and lower ESR can be secured, and the leakage current can be further reduced.

### (Technology 6)

In any one of (Technology 1) to (Technology 5), the second portion may include at least one continuous or discontinuous layer disposed between conductive polymer layers (specifically, second conductive polymer layers) adjacent to each other among the n or more conductive polymer layers. The at least one continuous or discontinuous layer may include at least a cationic agent. When the second portion includes such a layer, a second conductive polymer layer having a relatively large thickness is easily formed on the layer, and n is easily reduced. Therefore, since it is easy to maintain high conductivity of the second portion, it is easy to obtain lower ESR.

### (Technology 7)

A method of manufacturing an electrolytic capacitor according to another aspect of the present disclosure includes: a first step of preparing an anode body including a porous part in a surface layer and including a first end and a second end opposite to the first end; a second step of forming a dielectric layer on at least a part of a surface of the anode body; and a third step of forming a solid electrolyte layer covering at least a part of the dielectric layer. The solid electrolyte layer is formed in a portion including the second end of the anode body having the dielectric layer, and includes a first portion disposed in a void of the porous part and a second portion disposed outside a principal surface of the anode body having the dielectric layer. The second portion includes n or more conductive polymer layers on the principal surface of the anode body having the dielectric layer. The third step includes: a substep A of treating the portion including the second end of the anode body having the dielectric layer with a first treatment liquid including a first conductive polymer or a precursor of the first conductive polymer; a substep B of treating the portion including the second end of the anode body with a second treatment liquid including at least a cationic agent after the substep A; a substep C of treating the portion including the second end of the anode body with a third treatment liquid including a second conductive polymer and a water-soluble polymer after the substep B; and a substep D of repeating the substep B and the substep C. In the third step, the solid electrolyte layer is formed to satisfy following relational expressions.

$$\begin{matrix}18. μm \leq Tt \leq 45. μm \\ 9. μm \leq Tt / n \leq 12.5 μm\end{matrix}$$

where, n is an integer of 2 or more, and Tt is a thickness of the second portion on the principal surface of the anode body having the dielectric layer at the second end.

In the electrolytic capacitor obtained by the above manufacturing method, the thickness Tt of the second portion falls within a specific range, the ratio Tt/n falls within a specific range, and n≥2. Therefore, as described above, in the electrolytic capacitor, ESR is suppressed to be low, a leakage current is suppressed, and high withstand voltage characteristics are obtained.

### (Technology 8)

For the above (Technology 7), in the substep D, the substep B and the substep C may be repeated (n−1) times. In this case, the thickness Tt of the second portion can be more easily adjusted to the above range, and high withstand voltage characteristics can be easily obtained.

### (Technology 9)

In the above (Technology 7) or (Technology 8), the integer n may be 2 or more and 4 or less. In this case, since the total value of the interface resistances between the second conductive polymer layers can be further reduced, lower ESR is easily obtained.

### (Technology 10)

In any one of (Technology 7) to (Technology 9), a weight-average molecular weight (Mw) of the water-soluble polymer may be 50,000 or more and 800,000 or less. In this case, the number n of layers is relatively at least such that the thickness Tt and the ratio Tt/n can be easily adjusted to the above ranges. Therefore, high withstand voltage characteristics are obtained, and a leakage current is more easily suppressed. Furthermore, since high conductivity of the second portion is obtained, ESR can be further reduced.

### (Technology 11)

In any one of (Technology 7) to (Technology 10), a concentration of the water-soluble polymer in the third treatment liquid may be 1% by mass or more and 15% by mass or less. As a result, since the second portion includes the water-soluble polymer at an appropriate content, higher withstand voltage characteristics and lower ESR can be secured, and the leakage current can be further reduced.

Hereinafter, the electrolytic capacitor and the method of manufacturing the electrolytic capacitor of the present disclosure will be described in more detail, including the above (Technology 1) to (Technology 11). At least one selected from the components described below can be arbitrarily combined with at least one of the above (Technology 1) to (Technology 11) relating to the electrolytic capacitor or the method of manufacturing the electrolytic capacitor of the present disclosure, as long as the combination is technically possible.

### [Electrolytic Capacitor]

An electrolytic capacitor includes at least one capacitor element.

### (Capacitor Element)

A capacitor element includes an anode body, a dielectric layer covering at least a part of a surface of the anode body, and a cathode part covering at least a part of the dielectric layer. The cathode part includes a solid electrolyte layer covering at least a part of the dielectric layer.

### (Anode Body)

The anode body may contain, for example, a valve metal, an alloy containing a valve metal, and a compound (such as an intermetallic compound) containing a valve metal. These materials may be used singly or in combination of two or more kinds thereof. Examples of the valve metal include aluminum, tantalum, niobium, and titanium.

The anode body may be a foil (anode foil) of the above materials. The anode body may be a molded body of particles of the above materials (porous molded body) or a sintered body thereof (porous sintered body).

The anode body includes a first end and a second end opposite to the first end. The anode body includes, for example, an anode lead-out part including the first end and a cathode formation part including the second end. A cathode part including a solid electrolyte layer is formed on a surface of a portion (specifically, the cathode formation part) on a side of the second end of the anode body. The anode lead-out part is used, for example, for electrical connection with an external electrode on an anode side. An anode lead terminal may be connected to the anode lead-out part.

The anode body includes a porous part at least on a surface layer. The porous part includes many fine voids. Due to the porous part, the anode body has a fine uneven shape at least on the surface, the surface area is increased, and a high capacitance can be obtained. The porous part may be formed on a part of the surface layer of the anode body, or may be formed on the entire surface layer. In a case where the anode body is an anode foil, the porous part may be formed, for example, at least on the surface layer of the cathode formation part, or may be formed on at least a part of the surface layer of the anode lead-out part in addition to the surface layer of the cathode formation part. In a case where the anode body is a porous molded body or a porous sintered body, the entire anode body may constitute the porous part.

In a case where the anode body is an anode foil, the porous part is formed by roughening a surface of at least a portion corresponding to a cathode formation part of a base material (for example, metal foil) containing a valve metal. The roughening may be performed by etching or the like.

For example, an anode body having a sheet shape or a rectangular parallelepiped shape usually has six surfaces that define an outer shape of the anode body. Among these surfaces, a surface occupying the largest area (usually a pair of surfaces) may be referred to as a principal surface, and a surface other than the principal surface may be referred to as an end surface. For example, in a case where the anode body is an anode foil, the anode body includes a pair of principal surfaces occupying most of an area of the anode foil and end surfaces existing between the pair of principal surfaces. Even in a case where a part of the anode body includes a notch or unevenness, a surface occupying the largest area (usually a pair of surfaces) may be referred to as a principal surface, and a surface other than the principal surface may be referred to as an end surface in accordance with the above.

In the present specification, a direction from the first end toward the second end in a state where the anode body (anode foil or the like) is flat may be referred to as a length direction of the anode body. The direction from the first end side toward the second end side is a direction parallel to a linear direction connecting a center of an end surface of the first end and a center of an end surface of the second end. There may be a case where this direction is referred to as a length direction of the anode body or the capacitor element. Furthermore, a direction perpendicular to the length direction and a thickness direction of the anode body (or capacitor element) may be referred to as a width direction of the anode body (or capacitor element).

### (Dielectric Layer)

The dielectric layer is an insulating layer that functions as a dielectric. The dielectric layer is formed of a material that functions as a dielectric.

The dielectric layer contains, for example, a metal oxide as a material that functions as a dielectric. For example, in a case where the anode body contains tantalum as a valve metal, the dielectric layer contains Ta₂O₅. In a case where the anode body contains aluminum as a valve metal, the dielectric layer contains Al₂O₃. However, the dielectric layer is not limited thereto, and any dielectric layer may be used as long as the dielectric layer functions as a dielectric.

The dielectric layer is formed along inner wall surfaces of pores and depressions (pits) in the surface of the anode body, including an inner wall surface of the pores of the porous part. A surface of the dielectric layer has a fine uneven shape according to the shape of the surface of the porous part.

### (Cathode Part)

The cathode part includes at least a solid electrolyte layer covering at least a part of the dielectric layer. The solid electrolyte layer is formed in a portion on the second end side of the anode body (in other words, the cathode formation part) with the dielectric layer interposed therebetween. The cathode part usually includes a solid electrolyte layer covering at least a part of the dielectric layer, and a cathode lead-out layer covering at least a part of the solid electrolyte layer. Hereinafter, the solid electrolyte layer and the cathode lead-out layer will be described.

### (Solid Electrolyte Layer)

The solid electrolyte layer is formed on the second end side in the anode body having the dielectric layer. Then, in the anode body having the dielectric layer, the solid electrolyte layer includes a first portion disposed in the voids of the porous part and a second portion disposed outside the principal surface of the anode body having the dielectric layer.

Each of the first portion and the second portion of the solid electrolyte layer includes a conductive polymer (such as a conjugated polymer and a dopant). Each of the first portion and the second portion may include a conductive polymer layer. The solid electrolyte layer or the conductive polymer layer may further include an additive agent as necessary.

Examples of the conjugated polymer include known conjugated polymers used in solid electrolytic capacitors, such as π-conjugated polymers. Examples of the conjugated polymer include polymers having polypyrrole, polythiophene, polyaniline, polyfuran, polyacetylene, polyphenylene, polyphenylene vinylene, polyacene, and polythiophene vinylene as a basic skeleton. Among these polymers, a polymer that adopts polypyrrole, polythiophene, or polyaniline as a basic skeleton is preferable. The polymer is required to contain at least one kind of monomer unit constituting the basic skeleton. The monomer unit also includes a monomer unit having a substituent. The polymer also includes a homopolymer, and a copolymer of two or more kinds of monomer. Examples of polythiophene include poly(3,4-ethylenedioxythiophene) (PEDOT).

The substituent is preferably, but is not limited to, an alkyl group (C₁₋₄ alkyl groups such as methyl group and ethyl group, and the like), an alkoxy group (C₁₋₄ alkoxy groups such as methoxy group and ethoxy group, and the like), a hydroxy group, a hydroxyalkyl group (a hydroxy C₁₋₄ alkyl group such as a hydroxymethyl group, and the like), or the like. In a case where each of the pyrrole compound, thiophene compound, and aniline compound has two or more substituents, the respective substituents may be identical to or different from each other.

Each of the first portion and the second portion may contain one conjugated polymer, or may contain two or more conjugated polymers in combination. Each of the first portion and the second portion may contain one kind of dopant or a combination of two or more kinds of dopant.

A weight-average molecular weight (Mw) of the conjugated polymer is not particularly limited, and is, for example, 1,000 or more and 1,000,000 or less.

Note that the weight-average molecular weight (Mw) herein is a value in terms of polystyrene measured by gel permeation chromatography (GPC). Note that usually, the GPC is measured using a polystyrene gel column, and water and methanol (volume ratio 8:2) as a mobile phase.

The dopant may be at least one selected from the group consisting of an anion and a polyanion.

Examples of the anion include, but are not particularly limited to, a sulfate ion, a nitrate ion, a phosphate ion, a borate ion, an organic sulfonate ion, and a carboxylate ion. In a case where the dopant is an anion, for example, a relatively low molecular compound that generates an anion is used. Examples of the dopant that generates sulfonate ions include sulfonate compounds such as aromatic sulfonate compounds. Examples of the aromatic sulfonic acid compound include benzenesulfonic acid, p-toluenesulfonic acid, and naphthalenesulfonic acid. The sulfonic acid compounds may be used singly or in combination of two or more kinds thereof.

Specific examples of the polyanion include polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, and polyacrylic acid. A single one or two or more kinds in combination of these polymer dopants may be used. Furthermore, these may be a polymer of a single monomer or a copolymer of two or more kinds of monomers. Of these, a polyanion derived from polystyrenesulfonic acid is preferable.

The amount of the dopant contained in each of the first portion and the second portion is, for example, 10 parts by mass or more and 1000 parts by mass or less, and may be 20 parts by mass or more and 500 parts by mass or less with respect to 100 parts by mass of the conjugated polymer.

In each of the first portion and the second portion, the anionic group of the dopant may be contained in a free form, an anion form, or a salt form, or may be contained in a form bonded to or interacting with the conjugated polymer. All of these forms herein may be simply referred to as an “anionic group”, a “sulfonic acid group”, or a “carboxy group”, etc.

Each of the first portion and the second portion may contain one kind of water-soluble polymer, or may contain two or more kinds in combination. Since the treatment liquid containing the water-soluble polymer tends to have a high viscosity, it is preferable that the first portion does not contain the water-soluble polymer or has a small content of the water-soluble polymer even in a case where the first portion contains the water-soluble polymer. The content of the water-soluble polymer in the first portion may be, for example, 5% by mass or less or 1% by mass or less. On the other hand, in a case where the second portion contains a water-soluble polymer, the withstand voltage characteristics are further enhanced, and the leakage current can be further suppressed, which is preferable.

Examples of the water-soluble polymer include water-soluble polymer compounds having a hydrophilic group in a main chain or a side chain. Examples of the hydrophilic group of the water-soluble polymer include a polyoxyalkylene chain, a hydroxy group, and an acid group (carboxy group, sulfonic acid group, etc.). As the water-soluble polymer, a component having lower electron withdrawing properties than the dopant is typically used. Examples of such a water-soluble polymer include a water-soluble polymer having at least one hydrophilic group (first hydrophilic group) selected from the group consisting of a carboxy group, a hydroxy group, and a polyoxyalkylene chain. A water-soluble polymer having a first hydrophilic group and a sulfonic acid group may be used, or a water-soluble polymer not containing a sulfonic acid group may be used. Examples of the polyoxyalkylene chain include a polyoxy C₂₋₃ alkylene chain. The polyoxyalkylene chain may contain at least a polyoxyethylene chain. Examples of the water-soluble polymer include at least one selected from the group consisting of a polyalkylene glycol compound, a water-soluble polyurethane, a water-soluble polyamide, a water-soluble polyimide, a water-soluble acrylic resin, and polyvinyl alcohol. The water-soluble polymer preferably has at least a plurality of carboxy groups. Examples of such a water-soluble polymer include a polymer-type polycarboxylic acid, a resin into which a plurality of carboxy groups are introduced (water-soluble polyurethane resin, water-soluble polyamide, water-soluble polyimide, water-soluble acrylic resin, and the like), and the like.

The water-soluble acrylic resin also includes, for example, an acrylic polymer-type polycarboxylic acid. Examples of such a polymer-type polycarboxylic acid include a copolymer (an acrylic acid-methacrylic acid copolymer, a copolymer of at least one selected from the group consisting of acrylic acid and methacrylic acid and another copolymerizable monomer, and the like) using at least one of polyacrylic acid, polymethacrylic acid, acrylic acid, and methacrylic acid. As other copolymerizable monomers, for example, an acrylic acid ester (an alkyl ester, a hydroxyalkyl ester or the like), a methacrylic acid ester (an alkyl ester, a hydroxyalkyl ester, or the like), a vinyl compound (vinyl cyanide, olefin, an aromatic vinyl compound or the like), a polycarboxylic acid having a polymerizable unsaturated bond (a maleic acid, a fumaric acid or the like), and acid anhydrides of these materials can be named. The copolymer may include one kind or two or more kinds of monomer units derived from other copolymerizable monomers.

Acid groups such as a carboxy group and a sulfonic acid group of the water-soluble polymer may be contained in the solid electrolyte layer in a free form, an anion form, or a salt form as in the case of the dopant. Furthermore, some of the acid groups may be contained in the solid electrolyte layer in a form of bonding or interacting with the conjugated polymer. The carboxy group in all these forms herein may be simply referred to as a “carboxy group”, and the sulfonic acid group in all these forms herein may be simply referred to as a “sulfonic acid group”.

The weight-average molecular weight (Mw) of the water-soluble polymer is, for example, 1000 or more and 1000,000 or less, may be 10,000 or more and 800,000 or less, and preferably 50,000 or more and 800,000 or less.

In the solid electrolyte layer, at least one continuous or discontinuous layer may be interposed between adjacent conductive polymer layers. This continuous or discontinuous layer may contain at least a cationic agent. The continuous or discontinuous layer may include a cationic agent and an anionic agent. The continuous or discontinuous layer may optionally further include a surfactant. Here, as the surfactant, a component different from the cationic agent and the anionic agent is used. More specifically, the continuous or discontinuous layer is interposed between adjacent first conductive polymer layers, between the first conductive polymer layer and the second conductive polymer layer, and between adjacent second conductive polymer layers. By providing such a continuous or discontinuous layer, a large number of conductive polymers can be easily attached onto the conductive polymer layer, and the film-forming property of the conductive polymer layer can be enhanced. In particular, in a case where the second portion includes such a continuous or discontinuous layer, even if the number n of the second conductive polymer layers is relatively small, the thickness Tt and the ratio Tt/n can be increased, and it is easy to adjust the thickness Tt and the ratio Tt/n to the above ranges. In a case where an anionic agent is used, the dissociability of the cationic agent can be enhanced in a treatment liquid (second treatment liquid) for forming a continuous or discontinuous layer, and the film-forming property of the conductive polymer layer is further improved.

The cationic agent has a cationic group. The cationic agent is not particularly limited as long as it can generate a cation in a dissociated state. Examples of the cationic agent include an organic compound (an organic base or the like) containing an N element and a metal compound (an inorganic base or the like such as a metal hydroxide). As the cationic group of the cationic agent that is an organic compound, an amino group (a primary amino group, a secondary amino group, a tertiary amino group, and the like) and a quaternary ammonium group can be preferably used. Such cationic groups also include salts of amino groups, salts of quaternary ammonium groups, and the like. Each of the first portion and the second portion may contain one kind of cationic agent or two or more kinds of cationic agents.

Specific examples of the cationic agent include diamines (1,4-diaminobutane, 1,6-diaminohexane, 1,8-diaminooctane, 1,10-diaminodecane, diaminocyclohexane, diaminobenzene, diaminonaphthalene, and the like) and tertiary amines (N,N-dimethylhexylamine, N,N-dimethyloctylamine, N,N-diethyloctylamine, and the like). However, the cationic agent is not limited thereto.

Each of the first portion and the second portion may contain the cationic agent in any form among an amine compound, a cation corresponding to the amine compound, a quaternary ammonium compound, and a salt of the cation. For example, in each of the first portion and the second portion, the cationic agent may form a salt with the anionic agent or may interact with the dopant.

The anionic agent has an anionic group. As the anionic agent, for example, at least one selected from the group consisting of anions and polyanions exemplified as dopants of the first conductive polymer and the second conductive polymer may be used. As the anionic agent, an anionic agent having lower electron withdrawing properties than the dopant of each of the conductive polymers may be used. Each of the first portion and the second portion may contain one anion agent or two or more anion agents.

In each of the first portion and the second portion, the anionic group of the anionic agent may be contained in any form selected from the anionic group, an anion corresponding to the anionic group, a salt of the anion, and the like.

Examples of the anionic agent include a sulfonic acid compound (methanesulfonic acid, benzenesulfonic acid, styrenesulfonic acid, and the like), a phosphonic acid compound (phenylphosphonic acid or the like), a carboxylic acid (salicylic acid, phthalic acid, and the like), a hydroxyalkyl ester of a carboxylic acid (hydroxyethyl acrylate, hydroxyethyl methacrylate, and the like), and a phenol compound. Furthermore, an anionic agent having two or more kinds of anionic groups may be used. Examples of such an anionic agent include sulfosuccinic acid, sulfobenzoic acid, sulfosalicylic acid, disulfosalicylic acid, sulfophthalic acid, sulfoisophthalic acid, sulfoterephthalic acid, naphtholsulfonic acid, 2-(dihydroxyphosphinyloxy) acrylic acid, phosphonoacrylic acid, and 2-methyl-3-phosphonoacrylic acid.

Polymer type anionic agents may be used. Examples of such an anionic agent include acid phosphoxypolyoxyalkylene glycol monoacrylates (acid phosphooxypolyoxyethylene glycol mono (meth) acrylate (P(═O)(OH)₂—(O—CH₂CH₂)ₙ—O—C(═O)—CR═CH₂) (n is an integer of 2 to 10, and R is a hydrogen atom or a methyl group), etc.) of carboxylic acids such as acid phosphoxyethyl acrylate and acid phosphoxyethyl methacrylate, and aliphatic phosphonic acids (vinylphosphonic acid and the like).

The surfactant contained in the continuous or discontinuous layer may be either a nonionic surfactant or an ionic surfactant. The ionic surfactant includes cationic surfactants, anionic surfactants, and amphoteric surfactants. The continuous or discontinuous layer may contain one surfactant, or may contain two or more surfactants in combination.

Each of the first portion and the second portion may further contain at least one selected from the group consisting of a known additive agent and a known conductive material other than the conductive polymer as necessary. Examples of conductive material include at least one kind selected from the group consisting of conductive inorganic materials such as manganese dioxide and TCNQ complex salts. Furthermore, a layer or the like for enhancing adhesion may be interposed between the dielectric layer and the first portion (or the first conductive polymer layer).

### (First Portion)

The conductive polymer (first conductive polymer) contained in the first portion is formed using, for example, a treatment liquid (first treatment liquid) containing the first conductive polymer or a precursor thereof. The first conductive polymer is disposed in voids of the porous part of the anode body so as to cover at least a part of the dielectric layer.

In the first portion, the first conductive polymer layer may be a single layer or a plurality of layers. In a case where the first portion includes a plurality of the first conductive polymer layers, the first conductive polymers included in the respective layers may be the same or different.

Note that, when the second portion is formed using a treatment liquid (second treatment liquid) containing the second conductive polymer, the second conductive polymer may enter voids of the porous part of the anode body having the dielectric layer. Therefore, the first portion may contain the second conductive polymer. Furthermore, the first conductive polymer may adhere to a surface of a protrusion of the porous part of the anode body having the dielectric layer, and the second conductive polymer layer may be stacked on the adhering first conductive polymer. Therefore, the second portion may contain the first conductive polymer.

### (Second Portion)

The second portion includes n or more conductive polymer layers (second conductive polymer layers) on one principal surface of the anode body having the dielectric layer. n is an integer of 2 or more. When n is less than 2, it is difficult to adjust the thickness Tt and the ratio Tt/n of the second portion to predetermined ranges. n may be 5 or less or 4 or less. In the present disclosure, as described above, even if n is relatively small, a certain thickness Tt in the second portion can be secured. Therefore, high withstand voltage characteristics can be obtained and a leakage current can be suppressed while ensuring low ESR.

In each of the second conductive polymer layers included in the second portion, types, compositions, contents, and the like of the conductive polymer, the additive agent, and the like may be the same or different.

The thickness Tt of the second portion satisfies 18.0 μm≤Tt≤50.0 μm. Tt preferably satisfies Tt>20.0 μm, and more preferably satisfies Tt≥22.0 μm. When Tt is in such a range, high withstand voltage characteristics can be obtained. When the thickness Tt is in such a range even if the number n of layers is small, a total value of interface resistances between the second conductive polymer layers in the second portion can be reduced, and ESR can be suppressed low. When the thickness Tt exceeds 50.0, defects are likely to occur in the dielectric layer due to stress associated with thermal shrinkage when the second portion is formed, and a leakage current tends to be remarkable. On the other hand, when the thickness Tt is 50.0 μm or less, the leakage current can be reduced. From the viewpoint of further suppressing the leakage current, the thickness Tt may be 45.0 μm or less.

The thickness Tt may be 18.0 μm≤Tt≤50.0 μm (or 45.0 μm), 20.0 μm<Tt≤50.0 μm (or 45.0 μm), or alternatively 22.0 μm≤Tt≤50.0 μm (or 45.0 μm).

The ratio Tt/n satisfies 9.0 μm≤Tt/n≤12.5 μm. When Tt/n is less than 9.0 μm, it is necessary to increase the number n of layers in order to set the thickness Tt within the above range, and the ESR increases as the total value of the interface resistance increases. The ratio Tt/n may be Tt/n≥9.5 μm or Tt/n≥9.8 μm. When the ratio Tt/n is in such a range, the ESR can be further reduced. The ratio Tt/n may be Tt/n≤12.0 μm or Tt/n≤11.5 μm. In a case where the ratio Tt/n is in such a range, the thickness Tt is easily adjusted to the above range, and a higher effect is easily obtained.

The thickness Tt of the second portion and number n of the second conductive polymer layers are determined from a Raman spectrum of a cross section parallel to the length direction of the anode body and perpendicular to the thickness direction (stacking direction of the second conductive polymer layers) in the electrolytic capacitor or the capacitor element.

For the measurement of the Raman spectrum, a sample collected by the following procedure can be used. First, an electrolytic capacitor or a capacitor element is embedded in a curable resin to cure the curable resin. By subjecting the cured product to polishing treatment or cross section polisher processing, a cross section parallel to the length direction of the capacitor element (or anode body) and perpendicular to the thickness direction (stacking direction of the second conductive polymer layer) is exposed at the center in the width direction of the capacitor element (or anode body). In this way, a sample for measurement is obtained. In the exposed cross section of the sample, a Raman spectrum is measured for at least a portion on the second end side of the second portion.

In the present specification, the Raman spectrum of the second portion is measured for the solid electrolyte present in the cross section of the porous part at a predetermined position of the capacitor element under the following conditions.

Raman spectrometer: RamanFORCE PAV manufactured by NanoPhoton Corporation

Diffraction grating: 300 gr/mm

Measurement wavenumber range: 200 cm⁻¹ or more and 4500 cm⁻¹ or less

Temperature: 25° C.

Laser light wavelength: 532 nm

Laser intensity: 1600 W/cm²

Exposure time: 8 seconds

Number of integrations: 16 times

Coloring of conductive polymer: In a case where the conjugated polymer is PEDOT, the Raman spectrum is colored such that a ratio of an average intensity I₁ in a range of 1415 cm⁻¹ or more and 1460 cm⁻¹ or less to an average intensity I2 in a range of 1100 cm-¹ or more and 1170 cm⁻¹ or less: I₁/I₂ is 1.0 or more and 2.0 or less. A portion having an I₁/I₂ ratio of 1.7 or more is determined as PEDOT. Note that the average intensity I₁ is an average intensity in a wave number range covering a peak characteristic of the conjugated polymer, and the average intensity I₂ is an average intensity in a wave number range corresponding to a baseline of the peak. In the case of other conjugated polymers, the conductive polymer portion is colored in accordance with the case of PEDOT.

In the Raman spectrum, the thickness of the solid electrolyte layer (second portion) formed on one principal surface of the anode body is measured at the second end (more specifically, a position of the most end of the second end) of the anode body. The thickness of the solid electrolyte layer (second portion) formed on the principal surface on the opposite side is measured. Then, by summing and averaging these thicknesses, the thickness Tt (unit: m) of the second portion is obtained.

In the Raman spectrum, for example, the second conductive polymer layer in a layered state is confirmed by the coloring. The number of second conductive polymer layers formed on one principal surface of the anode body is measured to determine n. The ratio Tt/n (unit: μm) is obtained by dividing the thickness Tt by n.

The second portion preferably contains a water-soluble polymer as described above. In particular, in a case where the second portion contains a water-soluble polymer having a weight-average molecular weight (Mw) of 50,000 or more and 800,000 or less, the thickness Tt and the ratio Tt/n can be easily adjusted to the above ranges even if the number n of the second conductive polymer layers is relatively small. Therefore, more excellent effects can be obtained in reducing the ESR, suppressing the leakage current, and improving the withstand voltage characteristics.

The content of the water-soluble polymer in the second portion may be 5% by mass or more and 20% by mass or less, or may be 10% by mass or more and 20% by mass or less. In a case where the content of the water-soluble polymer is in such a range, higher withstand voltage characteristics can be secured, and the leakage current can be further suppressed. Since it is easy to ensure high conductivity of the second portion, it is advantageous in further reducing the ESR.

The content of the water-soluble polymer in the second portion can be determined using a sample (Hereinafter, referred to as sample A) of the second portion collected from the cross section of the sample. More specifically, the second portion is scraped from the cross section, a predetermined amount of sample A is collected, and the mass is measured. A water-soluble polymer is extracted from sample A with water at 20° C. to 40° C. The extract is concentrated and the water-soluble polymer is identified by liquid chromatography mass spectrometry (LC-MS) or gas chromatography mass spectrometry (GC-MS). The concentration of the water-soluble polymer in the extract is obtained by a calibration curve method. From this concentration and the mass of sample A, the content (% by mass) of the water-soluble polymer in the second portion is determined. The above sample is prepared by embedding an electrolytic capacitor or a capacitor element in an acrylic resin, cutting the electrolytic capacitor or the capacitor element in a direction parallel to the length direction at a center of the capacitor element in the width direction to expose a cross section, and polishing the cross section. Note that the content of the water-soluble polymer in the first portion is also determined according to the case of the content in the second portion.

### (Cathode Lead-Out Layer)

The cathode lead-out layer only needs to include at least a first layer that is in contact with the solid electrolyte layer and covers at least a part of the solid electrolyte layer, and may include a first layer and a second layer that covers at least a part of the first layer.

Examples of the first layer include a layer containing conductive particles, and metal foil. Examples of the conductive particles include at least one kind selected from conductive carbon and metal powder. The cathode part (more specifically, the cathode lead-out layer) may include a layer containing metal powder (such as a metal particle-containing layer). The cathode lead-out layer may include, for example, a layer containing conductive carbon (carbon layer) as the first layer and a layer containing metal powder (metal particle-containing layer or the like) or a metal foil as the second layer.

In a case where the cathode lead-out layer includes a metal foil or a metal particle-containing layer, the entire cathode lead-out layer may include a metal foil or a metal particle-containing layer. Furthermore, at least one of the first layer and the second layer may include a metal particle-containing layer.

Examples of the conductive carbon include graphite (artificial graphite, natural graphite, and the like).

The layer containing metal powder as the second layer can be formed by stacking a composition containing metal powder on a surface of the first layer, for example. Examples of such a second layer include a metal particle-containing layer formed using a paste containing metal powder and a resin binder. As the resin binder, a thermoplastic resin can be used, but it is preferable to use a thermosetting resin such as an imide resin or an epoxy resin. From the viewpoint of easily obtaining high conductivity of the second layer, silver-containing particles may be used as the metal powder. Examples of the silver-containing particles include silver particles and silver alloy particles. The second layer may contain one kind of silver-containing particles, or may contain two or more kinds in combination. The silver particles may contain minor amounts of impurities.

In a case where metal foil is used as the first layer, a kind of metal constituting the metal foil is not particularly limited. The metal foil is preferably formed using a valve metal such as aluminum, tantalum, or niobium, or an alloy containing the valve metal. The metal foil has a surface that may be roughened as necessary. The surface of the metal foil may be provided with an anodization film, and may be provided with a film of metal (dissimilar metal) different from the metal constituting the metal foil, or a nonmetal film. Examples of the dissimilar metals and nonmetals include metals such as titanium and nonmetals such as carbon (conductive carbon and the like).

The first layer may be formed of a film of the dissimilar metal or the nonmetal such as conductive carbon, and the second layer may be formed of the metal foil described above.

### (Separator)

In a case where the metal foil is used for the cathode lead-out layer, a separator may be disposed between the metal foil and the anode foil as the anode body. The separator is not particularly limited. For example, it is possible to use an unwoven fabric including fibers of cellulose, polyethylene terephthalate, vinylon, or polyamide (for example, aliphatic polyamide or aromatic polyamide such as aramid).

### (Others)

The electrolytic capacitor includes at least one capacitor element. The electrolytic capacitor may be a wound type, or may be either a chip type or a stack type. For example, the electrolytic capacitor may include a plurality of stacked capacitor elements. Furthermore, the electrolytic capacitor may include two or more wound type capacitor elements. The configuration of the capacitor element may be selected in accordance with the type of the electrolytic capacitor.

### [Method of Manufacturing Electrolytic Capacitor]

The electrolytic capacitor is formed, for example, by a manufacturing method including a first step of preparing an anode body, a second step of forming a dielectric layer on at least a part of a surface of the anode body, and a third step of forming a solid electrolyte layer covering at least a part of the dielectric layer. The manufacturing method may further include a fourth step of forming a cathode lead-out layer covering the solid electrolyte layer. A capacitor element is formed by the first step to the third step (or the fourth step). The method of manufacturing an electrolytic capacitor may further include a fifth step of connecting a lead terminal to the capacitor element, and a sixth step of sealing the capacitor element.

### (First Step)

In the first step, an anode body including a porous part in at least a surface layer and including a first end and a second end is prepared. In a case where the anode body is an anode foil, for example, as described above, the metal foil is subjected to etching treatment to obtain an anode foil in which a porous part is formed on a surface layer. The etching treatment may be performed by electrolytic etching or chemical etching. In a case where the anode body is a porous molded body or a porous sintered body, for example, an anode body is obtained by molding particles containing a valve metal or by sintering a molded body obtained by molding.

### (Second Step)

In the second step, a dielectric layer is formed on at least a part of the surface of the anode body. The dielectric layer is formed, for example, by anodizing the valve metal on the surface of the anode body by an anodizing treatment or the like.

### (Third Step)

In the third step, a solid electrolyte layer is formed on the anode body having the dielectric layer so as to cover at least a part of the dielectric layer. The solid electrolyte layer is formed on the second end side in the anode body having the dielectric layer. Then, as described above, the solid electrolyte layer includes the first portion disposed in the voids of the porous part and the second portion disposed outside the principal surface of the anode body having the dielectric layer. The second portion includes n or more conductive polymer layers on one principal surface of the anode body having the dielectric layer. n can be selected from the above ranges. According to the third step, the solid electrolyte layer is formed at the second end such that the thickness Tt of the second portion and the ratio Tt/n fall within the above-mentioned ranges.

More specifically, the third step includes at least:
substep A of treating a second end side of the anode body having the dielectric layer with a first treatment liquid containing a first conductive polymer or a precursor thereof;
substep B of treating the second end side of the anode body with a second treatment liquid containing at least a cationic agent after substep A;
substep C of treating the second end side of the anode body with a third treatment liquid containing a second conductive polymer and a water-soluble polymer after substep B; and
substep D of repeating substep B and substep C.

In substep D, substep B and substep C may be repeated (n−1) times.

### (Substep A)

In substep A, a layer (first conductive polymer layer) containing a first conductive polymer containing a conjugated polymer and a dopant may be formed by chemically polymerizing and/or electrolytically polymerizing a precursor of the conjugated polymer on the dielectric layer using a first treatment liquid containing the precursor of the conjugated polymer and the dopant. Examples of the precursor include at least one selected from a monomer, an oligomer, and a prepolymer of a conjugated polymer.

In a case where a treatment liquid containing a precursor of a conjugated polymer is used, an oxidizing agent is used to polymerize the precursor. The oxidizing agent may be contained in the treatment liquid as an additive agent. Furthermore, the oxidizing agent may be applied to the anode body before or after the treatment liquid is brought into contact with the anode body on which the dielectric layer is formed. Examples of such an oxidizing agent include a compound capable of generating Fe³⁺ (such as a ferric sulfate), a persulfate (such as a sodium persulfate or an ammonium persulfate), and a hydrogen peroxide. The oxidizing agent may be used with one kind thereof or two or more kinds thereof in combination.

Furthermore, the first conductive polymer layer may be formed by bringing a first treatment liquid (solution or dispersion liquid) containing the first conductive polymer into contact with the dielectric layer. Usually, after the first treatment liquid is brought into contact with the dielectric layer, a drying treatment (heat drying or the like) is performed.

The attachment and polymerization (or drying) of the first treatment liquid to the anode body having the dielectric layer may be performed once or may be repeated a plurality of times. In the case of repeating a plurality of times, conditions such as the composition and viscosity of the first treatment liquid may be the same in each time, or at least one condition may be changed.

In a case where the first conductive polymer layer contains a water-soluble polymer, the first treatment liquid may contain a water-soluble polymer. For the component contained in the first conductive polymer layer, the description of the solid electrolyte layer or the first portion can be referred to.

If necessary, before substep C, substep A and substep B may be alternately repeated.

### (Substep B)

In substep B, after substep A, the second end side of the anode body is treated with the second treatment liquid. The second treatment liquid contains at least a cationic agent. The second treatment liquid may contain a cationic agent and an anionic agent. The second treatment liquid may further contain a surfactant. As the component contained in the second treatment liquid, the description of the continuous or discontinuous layer described above can be referred to.

### (Substep C)

In substep C, after substep B, a third treatment liquid containing a second conductive polymer (and a water-soluble polymer) is brought into contact with a portion of the anode body on the second end part side. After the third treatment liquid is brought into contact with the portion on the second end side, a drying treatment (heat drying or the like) is usually performed. In this way, the second conductive polymer layer containing the second conductive polymer (and the water-soluble polymer) is formed.

For the components contained in the third treatment liquid, the description of the solid electrolyte layer or the second portion can be referred to.

The concentration of the water-soluble polymer in the third treatment liquid may be 1% by mass or more and 15% by mass or less, or may be 5% by mass or more and 15% by mass or less. In a case where the concentration of the water-soluble polymer is in such a range, it is easy to adjust the thickness Tt and the ratio Tt/n to the above-described ranges.

### (Substep D)

In substep D, substep B and substep C are repeated (n−1) times. As a result, the number n of the second conductive polymer layers can be adjusted, and the thickness Tt of the second portion can be adjusted.

### (Fourth Step)

In the fourth step, a cathode lead-out layer is formed. The cathode lead-out layer is formed by a known method according to the layer configuration.

For example, in a case where the cathode lead-out layer includes a metal foil as the first layer or the second layer, the first layer or the second layer is formed by stacking the metal foil so as to cover at least a part of the solid electrolyte layer or the first layer. The first layer containing conductive particles is formed, for example, by applying a conductive paste or a liquid dispersion containing conductive particles and, if necessary, a resin binder (water-soluble resin, curable resin, etc.) to the surface of the solid electrolyte layer. The second layer containing metal powder is formed, for example, by applying a paste containing metal powder and a resin binder to the surface of the first layer. In the process of forming the cathode lead-out layer, a drying treatment, a heat treatment, or the like may be performed as necessary.

### (Fifth Step)

In the fifth step, a lead terminal is connected to the capacitor element. In the capacitor element, one end of the cathode lead terminal may be electrically connected to the cathode lead-out layer. For example, a conductive adhesive is applied to the cathode lead-out layer, and the cathode lead terminal is bonded to the cathode lead-out layer via the conductive adhesive. One end portion of the anode lead terminal may be electrically connected to the anode lead-out part of the anode body.

The other end of the anode lead terminal and the other end of the cathode lead terminal are drawn out from the resin outer packing or the case, respectively, when the capacitor element is sealed in the sixth step. The other end of each terminal exposed from the resin outer packing or the case is used for solder connection with a substrate on which an electrolytic capacitor is to be mounted.

The fifth step is not limited to the case of pulling out the lead terminal. In the fifth step, for example, the lead frame may be connected to the capacitor element. In this case, in the sixth step, the end surface of the lead frame may be exposed from the outer surface of the resin outer packing. Furthermore, in the fifth step, at least one end surface of the anode part and the cathode part may be exposed from the outer surface of the resin outer body in the sixth step. The end surface of the lead frame exposed in the sixth step, the end surface of the anode part, and the end surface of the cathode part are electrically connected to the external electrode.

### (Sixth Step)

The capacitor element is sealed using the resin exterior body or the case. For example, the capacitor element and a material resin (e.g., uncured thermosetting resins and fillers) of the exterior body may be housed in a mold, and the capacitor element may be sealed with the resin exterior body by a transfer molding method, a compression molding method, or the like. At this time, the other end side portions of the anode lead terminal and the cathode lead terminal connected to the anode lead drawn out from the capacitor element are exposed from the mold. Furthermore, the electrolytic capacitor may be formed by housing the capacitor element in the bottomed case such that the other end side portions of the anode lead terminal and the cathode lead terminal are positioned on the opening side of the bottomed case, and sealing the opening of the bottomed case with a sealing body.

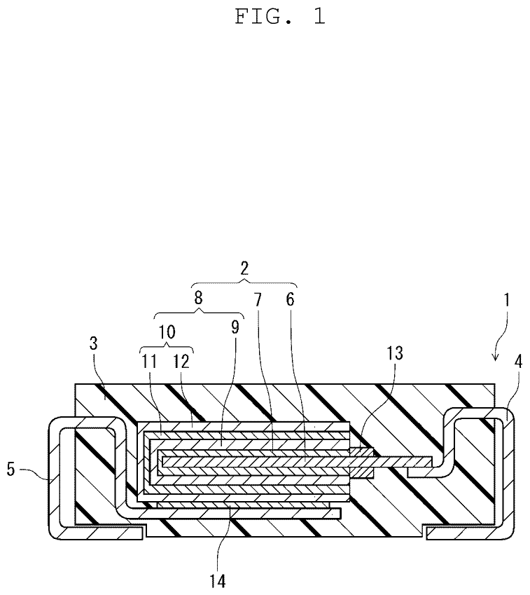

FIG. 1 is a cross-sectional view schematically illustrating a structure of a solid electrolytic capacitor according to one exemplary embodiment of the present disclosure. FIG. 1 is a schematic cross-sectional view of a solid electrolytic capacitor in a direction parallel to both a length direction and a thickness direction of capacitor element 2. As illustrated in FIG. 1, solid electrolytic capacitor 1 includes capacitor element 2, resin exterior body 3 that seals capacitor element 2, and anode lead terminal 4 and cathode lead terminal 5 that are each at least partially exposed to an outside of resin exterior body 3. Anode lead terminal 4 and cathode lead terminal 5 can be made of metal such as copper or a copper alloy, for example. Resin exterior body 3 has a substantially rectangular parallelepiped outer shape, and solid electrolytic capacitor 1 also has a substantially rectangular parallelepiped outer shape.

Capacitor element 2 includes anode body 6, dielectric layer 7 covering anode body 6, and cathode part 8 covering dielectric layer 7. Cathode part 8 includes solid electrolyte layer 9 covering dielectric layer 7, and cathode lead-out layer 10 covering solid electrolyte layer 9. Cathode lead-out layer 10 includes carbon layer 11 covering solid electrolyte layer 9, and metal particle-containing layer 12 covering carbon layer 11.

Anode body 6 includes a region facing cathode part 8 and a region not facing cathode part 8. In a region of anode body 6 not opposed to cathode part 8, insulating separation part (insulating region) 13 is formed in a portion adjacent to cathode part 8 so as to cover a surface of anode body 6 in a band shape, thereby restricting contact between cathode part 8 and anode body 6. In the region of anode body 6 that does not face cathode part 8, the other part is electrically connected to anode lead terminal 4 by welding. Cathode lead terminal 5 is electrically connected to cathode part 8 via adhesive layer 14 formed of a conductive adhesive.

### Examples

Hereinafter, the present disclosure is specifically described with reference to examples and comparative examples, but the present disclosure is not limited to the following examples.

Electrolytic capacitor 1 illustrated in FIG. 1 was produced in the following manner, and properties of electrolytic capacitor 1 were evaluated.

### (1) Step of Preparing Anode Body 6 (First Step)

Both surfaces of an aluminum foil (thickness: 100 μm) as a base material were roughened by etching to prepare anode body 6.

### (2) Step of Forming Dielectric Layer 7 (Second Step)

A portion on the second end side of anode body 6 was immersed in an anodizing solution, and a DC voltage of 70 V was applied for 20 minutes to form dielectric layer 7 containing aluminum oxide.

### (3) Step of Forming Solid Electrolyte Layer 9 (Third Step)

### (3-1) Substep A

A 3,4-ethylenedioxythiophene monomer was added under stirring to an aqueous solution of polystyrene sulfonic acid (Mw: 75,000), and then oxidants (iron (III) sulfate and sodium persulfate) were added to the resulting mixture to carry out chemical oxidation polymerization. The obtained polymerization liquid was filtered by an ion exchanger to remove impurities, thereby obtaining a solution containing poly (3,4-ethylenedioxythiophene) (PEDOT) as a conjugated polymer and polystyrene sulfonic acid (PSS) as a dopant.

Pure water was added to the obtained solution, and the mixture was homogenized by a high-pressure homogenizer and was further subjected to filtration by a filter. As a result, a first treatment liquid in a state of a dispersion liquid was prepared. The concentration of the first conductive polymer (PEDOT and PSS) in the first treatment liquid was 2% by mass.

The portion on the second end side of anode body 6 having dielectric layer 7 obtained in the above second step (2) was immersed in the first treatment liquid, then taken out from the first treatment liquid, and further dried at 120° C. for 10 minutes to 30 minutes. By repeating the immersion in the first treatment liquid and the drying one more time, at least a part of the first portion containing the first conductive polymer was formed so as to cover the surface of dielectric layer 7 and fill at least a part of a recess of the porous part.

### (3-2) Substep B

A second treatment liquid was prepared by dissolving N,N-dimethyloctylamine (cationic agent) and a copolymer (anionic agent) of styrenesulfonic acid and acid phosphonooxyethyl acrylate (P(═O)(OH)₂—O—CH₂CH₂—O—C(═O)—CH═CH₂) in pure water. The concentration of the cationic agent in the second treatment liquid was set to 0.05 mol/L, and the concentration of the anionic agent in the second treatment liquid was set to 0.03 mol/L.

Anode body 6 treated in substep A was immersed in the second treatment liquid, then taken out, and further dried at 100° C. for 3 minutes to attach the cationic agent and the anionic agent to the surface of the first conductive polymer.

Note that the anionic agent used in the second treatment liquid was produced as follows.

Sodium styrene sulfonate and acid phosphoxyethyl acrylate were added to a predetermined amount of pure water and were mixed with the pure water. As a result, a monomer solution was prepared. In performing such treatment, sodium styrenesulfonate and acid phosphoxyethyl acrylate were used at a ratio that a copolymerization ratio (a molar ratio) between a styrenesulfonic acid and acid phosphoxyethyl acrylate in a copolymer becomes 75:25. A predetermined amount of ammonium persulfate (an oxidizing agent) was added to the monomer solution under stirring, and a polymerization reaction was performed over 8 hours. Pure water and an ion exchange resin were added to the obtained polymerization liquid, stirred, and filtered to perform a purification treatment. This purification treatment was repeated a plurality of times to finally obtain the above-described copolymer. The molecular weight of the copolymer was measured by GPC, and the weight-average molecular weight (Mw) was found to be 83,000.

### (3-3) Substep C

A solution containing PEDOT and PSS was obtained in the same manner as in the above substep A (3-1). Pure water and, if necessary, an acrylic acid-methacrylic acid copolymer (water-soluble polymer) having a weight-average molecular weight (Mw) shown in Table 1 were added to the obtained solution, and the mixture was homogenized by a high-pressure homogenizer and further filtered by a filter to prepare a third treatment liquid in a dispersed liquid state. The concentration of the second conductive polymer in the third treatment liquid was 4% by mass, and the concentration of the water-soluble polymer was 11% by mass.

A portion on the second end side of anode body 6 obtained in substep B was immersed in the third treatment liquid, then taken out, and further dried at 120° C. for 10 minutes to 30 minutes. In this way, one second conductive polymer layer was formed.

### (3-4) Substep D

A portion on the second end side of anode body 6 obtained in substep C was subjected to substep B using the second treatment liquid. A portion on the second end side of anode body 6 obtained in this substep B was subjected to substep C using the above-described third treatment liquid. If necessary, this substep B and substep C were further repeated alternately. In substep D, substep B and substep C were repeated a total of (n−1) times to form solid electrolyte layer 9 having n second conductive polymer layers shown in Table 1. Most of the second conductive polymer layer may constitute a second portion formed on the principal surface of anode body 6, and a part of the second conductive polymer layer may be filled in the recess of the porous part of anode body 6.

Note that, in the example in which the second portion contained a water-soluble polymer, the content of the water-soluble polymer in the second portion determined by the procedure described above was in a range from 10 mass % to 20 mass %, inclusive.

### (4) Step of Forming Cathode Lead-Out Layer 10

A portion on the second end side of anode body 6 obtained in the above third step (3) was immersed in a dispersion liquid in which graphite particles were dispersed in water, taken out from the dispersion liquid, and then dried to form first layer (carbon layer) 11 at least on the surface of solid electrolyte layer 9. Drying was performed at a temperature in a range from 130° C. to 180° C. for 10 minutes to 30 minutes.

Next, a silver paste containing silver particles and a binder resin (epoxy resin) was applied onto the surface of the first layer 11, and heated at 150° C. to 200° C. for 10 minutes to 60 minutes to cure the binder resin, thereby forming a second layer (metal particle-containing layer) 12. Cathode lead-out layer 10 composed of first layer 11 and second layer 12 was thus formed.

Capacitor element 2 was produced as described above.

### (5) Assembly of Electrolytic Capacitor

Cathode lead-out layer 10 of capacitor element 2 obtained in the above step (4) was bonded to one end of cathode lead terminal 5 with an adhesive layer made of a conductive adhesive interposed therebetween. A first end of anode body 6 protruding from capacitor element 2 and one end of anode lead terminal 4 were joined by laser welding.

Next, resin exterior body 3 made of an insulating resin was formed around capacitor element 2 by a transfer molding method. At this time, the other end of anode lead terminal 4 and the other end of cathode lead terminal 5 were drawn out from resin exterior body 3.

In this way, electrolytic capacitor 1 was completed. In the same manner as described above, a total of 20 electrolytic capacitors 1 were produced for each example.

### (6) Evaluation

The following evaluations were performed using the electrolytic capacitors.

### (a) Thickness Tt and Ratio Tt/n

The thickness Tt (μm) of the second portion and number n of layers of the second conductive polymer layer were determined by the procedure described above. From these, the ratio Tt/n (μm) was calculated.

### (b) Initial Capacitance (Cap) and ESR

Under an environment of 20° C., initial electrostatic capacitance (μF) at a frequency of 120 Hz of each electrolytic capacitor was measured, and initial ESR (mΩ) at a frequency of 100 kHz was measured using an LCR meter for 4-terminal measurement. Then, initial electrostatic capacitance (Cap) and an average value of ESR in the 20 electrolytic capacitors were obtained.

### (c) Leakage Current (LC)

A resistance of 1 kΩ was connected in series to the electrolytic capacitor, and a leakage current (μA) after applying a rated voltage of 10 V for 20 seconds by a DC power supply was measured to determine an average value of 20 electrolytic capacitors.

### (d) Withstand Voltage Characteristics

Voltage was applied to 10 electrolytic capacitors among the electrolytic capacitors for which LC was measured while increasing the voltage at a rate of 1.0 V/sec, and a breakdown voltage (V) through which an overcurrent of 0.5 A flowed was measured. Then, an average value of the 10 electrolytic capacitors was obtained.

Table 1 show evaluation results. In Table 1, A1 to A3 are examples, and B1 to B5 are comparative examples.

TABLE 1

| | Water-soluble | Tt | Tt/n | | Cap | ESR | LC | Withstand voltage |
|---|---|---|---|---|---|---|---|---|
| | polymer Mw | (μm) | (μm) | n | (μF) | (mΩ) | (μA) | characteristics (V) |
| A1 | 53 × 10³-90 × 10³ | 39.2 | 9.8 | 4 | 13.7 | 33.1 | 2.7 | 71.1 |
| A2 | 151 × 10³-765 × 10³ | 44.1 | 11.0 | 4 | 14.1 | 42.8 | 0.4 | 79.9 |
| A3 | 151 × 10³-765 × 10³ | 22.7 | 11.4 | 2 | 15.0 | 26.9 | 34.0 | 74.2 |
| B1 | 151 × 10³-765 × 10³ | 82.3 | 13.7 | 6 | 14.0 | 39.0 | 62.2 | 98.7 |
| B2 | — | 13.6 | 6.8 | 2 | 15.5 | 48.8 | 199.6 | 33.6 |
| B3 | — | 44.4 | 7.4 | 6 | 12.5 | 79.6 | 1.8 | 37.2 |
| B4 | 151 × 10³-765 × 10³ | 9.9 | 9.9 | 1 | 15.7 | 24.4 | 10.9 | 38.3 |
| B5 | 53 × 10³-90 × 10³ | 61.6 | 10.3 | 6 | 13.6 | 33.4 | 65.1 | 75.9 |

As shown in Table 1, in the examples, as compared with the comparative examples, the leakage current can be kept low while relatively high electrostatic capacity and low ESR are secured, and relatively high withstand voltage characteristics can be secured. This is because the thickness Tt and the ratio Tt/n of the second portion satisfy 18.0 μm≤Tt≤50.0 μm and 9.0 μm≤Tt/n≤12.5 μm, respectively. In the case of Tt<18.0 μm, the withstand voltage characteristics are significantly reduced (comparison of B2 and B4 with A3). Even in the case of Tt<18.0 μm, the leakage current is relatively small (B4) in a case where the number n of the second conductive polymer layers is 1. This is considered to be because the number of times of heating and drying is small, so that stress due to thermal shrinkage is suppressed to be low, and occurrence of defects in the dielectric layer is suppressed. However, in the case of Tt<18.0 μm and n=2, the leakage current becomes significantly large (comparison between B4 and B2). This is considered to be because in addition to the small Tt, a larger stress is applied to the dielectric layer due to thermal shrinkage, and defects are likely to occur. Furthermore, when Tt>50 μm, high withstand voltage characteristics are obtained, but the leakage current increases (comparison between B1 and B5, and A2). This is considered to be because it is necessary to increase n in order to increase the thickness Tt, and the stress due to thermal shrinkage increases as the number of times of heating and drying increases, so that defects are likely to occur in the dielectric layer.

Even in a case where 18.0 μm≤Tt≤50.0 μm is satisfied, in the case of Tt/n<9.0 μm, the withstand voltage characteristics are low and the ESR increases as compared with the case of Tt/n≥9.0 μm (comparison between B3, and A1 and A2). In a case where 18.0 μm≤Tt≤50.0 μm and Tt/n<9.0 μm, n increases even if a certain degree of conductivity can be secured by the second conductive polymer layer. Therefore, interface resistance between adjacent second conductive polymer layers increases. Therefore, it is considered that the conductivity of the second portion as a whole decreases and the ESR increases. Furthermore, from the comparison between B3, and A1 and A2, in a case where the second conductive polymer layer contains a water-soluble polymer, a conductive polymer layer having a relatively uniform thickness tends to be easily formed, and the withstand voltage characteristics tend to be further increased.

Note that, in a case where the weight-average molecular weight (Mw) of the water-soluble polymer is 50,000 or more and 800,000 or less, the ratio Tn/n is easily adjusted to a range of 9.0 μm≤Tt/n≤12.5 μm as compared with a case where the weight-average molecular weight (Mw) is out of this range. Therefore, even when n is relatively small, it is easy to adjust the thickness Tt so as to satisfy 18.0 μm≤Tt≤50.0 μm. Therefore, stress applied to the dielectric layer by thermal shrinkage of the second conductive polymer layer can be easily reduced, and the total interface resistance between adjacent second conductive polymer layers can be reduced. Therefore, the leakage current can be further easily reduced, and higher withstand voltage characteristics can be obtained. In addition, since high conductivity of the entire second portion is easily secured, low ESR is easily obtained. Furthermore, in a case where the water-soluble polymer has a weight-average molecular weight (Mw) of 50,000 or more and 800,000 or less, it is easy to form the second conductive polymer layer having relatively uniform film quality and thickness.

The present disclosure can provide a high-quality electrolytic capacitor. Therefore, the electrolytic capacitor can be used for various applications.

What is claimed is:

1. An electrolytic capacitor comprising at least one capacitor element, the at least one capacitor element including:
an anode body including a porous part in a surface layer;
a dielectric layer covering at least a part of a surface of the anode body; and
a solid electrolyte layer covering at least a part of the dielectric layer, wherein:
the anode body includes a first end and a second end opposite to the first end,
the solid electrolyte layer is disposed in a portion including the second end of the anode body having the dielectric layer, and includes a first portion disposed in a void of the porous part and a second portion disposed outside a principal surface of the anode body having the dielectric layer, and
the second portion includes n or more conductive polymer layers on the principal surface of the anode body having the dielectric layer, and following relational expressions are satisfied:
$$\begin{matrix}18. μm \leq T t \leq 50. μm \\ 9. μm \leq Tt / n \leq 12.5 μm\end{matrix}$$
where, n is an integer of 2 or more, and Tt is a thickness of the second portion on one principal surface of the anode body having the dielectric layer at the second end.

2. The electrolytic capacitor according to claim 1, wherein the integer n is 4 or less.

3. The electrolytic capacitor according to claim 1, wherein a following relational expression is further satisfied,
$$20. μ m < Tt .$$

4. The electrolytic capacitor according to claim 1, wherein:
the second portion includes a water-soluble polymer, and
a weight-average molecular weight of the water-soluble polymer is 50,000 or more and 800,000 or less.

5. The electrolytic capacitor according to claim 4, wherein a content proportion of the water-soluble polymer in the second portion is 10 mass % or more and 20 mass % or less.

6. The electrolytic capacitor according to claim 1, wherein:
the second portion includes at least one continuous or discontinuous layer disposed between conductive polymer layers adjacent to each other among the n or more conductive polymer layers, and
the at least one continuous or discontinuous layer includes at least a cationic agent.

7. A method of manufacturing an electrolytic capacitor, the method comprising:
a first step of preparing an anode body including a porous part in a surface layer and including a first end and a second end opposite to the first end;
a second step of forming a dielectric layer on at least a part of a surface of the anode body; and
a third step of forming a solid electrolyte layer covering at least a part of the dielectric layer, wherein:
the solid electrolyte layer is formed in a portion including the second end of the anode body having the dielectric layer, and includes a first portion disposed in a void of the porous part and a second portion disposed outside a principal surface of the anode body having the dielectric layer,
the second portion includes n or more conductive polymer layers on the principal surface of the anode body having the dielectric layer,
the third step includes:
a substep A of treating the portion including the second end of the anode body having the dielectric layer with a first treatment liquid including a first conductive polymer or a precursor of the first conductive polymer;
a substep B of treating the portion including the second end of the anode body with a second treatment liquid including at least a cationic agent after the substep A;
a substep C of treating the portion including the second end of the anode body with a third treatment liquid including a second conductive polymer and a water-soluble polymer after the substep B; and
a substep D of repeating the substep B and the substep C, and
in the third step, the solid electrolyte layer is formed to satisfy following relational expressions:
$$\begin{matrix}18. μm \leq Tt \leq 45. μm \\ 9. μm \leq Tt / n \leq 12.5 μm\end{matrix}$$
where, n is an integer of 2 or more, and Tt is a thickness of the second portion on the principal surface of the anode body having the dielectric layer at the second end.

8. The method of manufacturing an electrolytic capacitor according to claim 7, wherein in the substep D, the substep B and the substep C are repeated (n−1) times.

9. The method of manufacturing an electrolytic capacitor according to claim 7, wherein the integer n is 2 or more and 4 or less.

10. The method of manufacturing an electrolytic capacitor according to claim 7, wherein a weight-average molecular weight of the water-soluble polymer is 50,000 or more and 800,000 or less.

11. The method of manufacturing an electrolytic capacitor according to claim 7, wherein a concentration of the water-soluble polymer in the third treatment liquid has 1% by mass or more and 15% by mass or less.
